(19) United States
(12) Patent Application Publication
(10) Pub. No.: US 2009/0076722 A1
(43) Pub. Date: Mar. 19, 2009

(54) ROAD PROFILER AND METHOD THEREFOR

(76) Inventor: John Darlington, East Lansing, MI (US)

Correspondence Address: PAPARELLA & ASSOCIATES, PLC, 3878 CASCADE RD. SE, GRAND RAPIDS, MI, 49546, US

(21) Appl. No.: 12/210,753

(22) Filed: Sep. 15, 2008

Related U.S. Application Data
(60) Provisional application No. 60/972,267, filed on Sep. 14, 2007.

(51) Int. Cl. G01C 21/00

(52) U.S. Cl. 701/207

(57) ABSTRACT

A profiling system to precisely locate and define a position along a traveled path includes a vehicle module, the vehicle module further comprising a light source and a receiver, and a marker, the marker further comprising a light sensing device and a transmitter, wherein the marker is adapted to respond to the light source by transmitting a signal to the receiver.

This application claims the benefit of the filing date of U.S. provisional application Ser. No. 60/972,267 entitled “Road Profiler and Method Therefor” which was filed on Sep. 14, 2007 and which is herein incorporated by reference.

### BACKGROUND OF THE INVENTION

The present invention relates to profiling generally, and more specifically to profiling transportation surfaces and the like.

In recent years, it has become common practice to utilize a variety of instrumented vehicles in order to evaluate the conditions of, for example, roadways, runways, railroads, and other transportation surfaces. These evaluations may include, again for example only, measuring these surfaces for variations in slope, height, and levelness in order to ensure that surface meets with predefined quality control measures. During these evaluations it is necessary to isolate, define, or mark out the desired test section(s) (e.g. beginning and end), as well as intermediate points of interest.

In particular, and with respect to these points of interest, it is customary to mark these points manually. This manual process typically comprises the use of painted marks and/or traffic cones which are positioned along the points of interest alongside the traveled path, and serve to advise or alert the vehicle operator of the particular point of interest. The operator would then manually annotate or record these marks in the profile, either by hand or by inputting them into a computer, as the operator drove the vehicle by the point of interest.

In the past, profiling technology was limited to being utilized on relatively slow moving vehicles. As such, the operator had ample time to record these various points of interest in an efficient and safe manner. However, with the advent of test vehicles that are able to profile at increased vehicle speeds, this manual recordation process has become difficult and in many cases, unsafe. For example, the driver (or assistant) was required to manually log the marker (point of interest). With vehicle speeds approaching 60 miles per hour, or faster, this manually marked location was imprecise and would generally introduced an error in the position of these measurements, typically on the order of several feet. Further, if an assistant was unavailable, this procedure must be performed by the driver of the vehicle and as such, introduced an unsafe practice to the routine. Alternatively, in utilizing an assistant, the costs of the profile are accordingly increased.

It is current practice in these systems to utilize a reflective photo switch, mounted on the vehicle, which responds to a reflective surface (marker) placed beside the roadway. In the alternative, a temporary reflective tape may be placed on the roadway itself. However, this approach has several drawbacks. Namely, it only produces a pulse and as such, there is no indication of what the marker identifies. Hence, the manual recordation of what the specific marker was set to identify must still be manually recorded. Other drawbacks include, for example: failure of these vehicle reflective photocells to respond to the marker; or recordation of an event when passing an unintended reflective object. These drawbacks then require the operator to manually intervene. For example, such interventions may be in the form of having the operator temporarily arm the photocell as he approaches the marker. Alternatively, the operator may be forced to abort the run altogether.

Further yet, in many instances intermediate regions, points, or markers must be identified during the profile, and since the aforementioned photocell simply produces a pulse, the operator must manually annotate these points during the run or thereafter. Of course, if done in the post profile stage, error is further introduced. And, if done during the profile, not only is human error involved, but having the operator make these annotations during the run introduces a safety issue. For these and other reasons, the use of this type of photocell system remains undesirable.

In order to solve the problems with the prior art profiling systems, a marker should meet the following criteria: it should respond quickly (accurately) when a designated part of the test vehicle is exactly opposite the marker to be profiled; it should respond reliably at vehicle speeds of 90 feet per second or greater; and, it should be capable of self-identification or self-reporting to the test vehicle.

Numerous technologies were examined in order to determine the preferred embodiments. In one experiment a barcode was utilized. The barcode was placed along the roadway and was to be read by a laser scanner. With the barcode feature, the system was capable of indentifying each marker through a unique or standardized barcode, thereby avoiding operator intervention. However, these systems were problematic as these barcode systems often need to be rescanned due to errors in reading the code. They also exhibited poor response time and therefore were not as accurate as desired.

Yet another approach involved active and/or passive Radio Frequency Identification (RFI) devices to accomplish the same goals as outlines above. These systems were also found to be unacceptable due to range and response time problems.

Accordingly, a need exists for novel systems and methods which have, among other advantages, increased safety and self-reporting features, while simultaneously accurately logging and reporting specific and desired information. Therefore, road profiling systems and methods that solve the aforementioned disadvantages and having the aforementioned advantages are desired.

### SUMMARY OF THE PRESENT INVENTION

The aforementioned drawbacks and disadvantages of these former road profiling systems have been identified and a solution is set forth herein by the inventive road profiling system and method which includes, a profiling system to precisely locate and define a position along a traveled path. The system comprises a vehicle module, wherein the vehicle module further comprises a light source and a receiver. The system further includes a marker, wherein the marker further comprises a light sensing device and a transmitter. The marker is adapted to respond to the light source by transmitting a signal to the receiver.

Another aspect of the present invention includes a profiling system to precisely locate and define a position along a traveled path, wherein the system includes a vehicle module, the vehicle module further comprising a light source, a lens for focusing an emitted light from the light source, and a receiver. The system further includes a marker, the marker further comprising a light sensing device, a light filter which is adapted to restrict the light received by the light sensing device, a second lens for focusing the light received by the light sensing device, an aperture which is adapted to limit the light received by the light sensing device, and a transmitter. The marker is adapted to generate a signal in response to the light sensing device receiving emitted light from the light source, the signal adapted to convey user-defined information, thereby allowing one or more points of interest along a traveled path to be isolated.

In another aspect of the present invention, a profiling system to precisely locate and define a position along a traveled path is disclosed. The system includes a vehicle module, the vehicle module further comprising at least one infrared light emitting diode light source, a cylindrical lens for focusing an emitted light from the light source, and a radio frequency receiver. The system further includes a marker, the marker further comprising a photocell, a light filter which is adapted to restrict the light received by the photocell, a cylindrical Fresnel lens for focusing the light received by the photocell, a slit aperture which is adapted to limit the light received by the photocell, and a radio frequency transmitter. The radio frequency transmitter is adapted to generate a radio frequency signal in response to the photocell receiving emitted light from the at least one infrared light emitting diode, the radio frequency signal adapted to convey user-defined information, thereby allowing for the indication of one or more points of interest along a traveled path.

And still in another aspect of the present invention, a method of precisely marking a position along a traveled path is disclosed. The method comprises providing a vehicle module, the vehicle module further comprising a light source and a receiver; providing one or more markers, the markers further comprising a light sensing device and a transmitter, wherein the marker further includes predefined data; positioning the one or more markers at desired locations along a traveled path; activating the light source; moving the vehicle module along the traveled path and by the one or more markers; activating the transmitter by moving the vehicle module by the marker, thereby passing the light source over the light sensing device, the transmitter activated to generate a signal in response to the light sensing device receiving light from the light source; generating a signal by the transmitter which comprises the predefined data; receiving the signal including the predefined data in the generated signal by the receiver, thereby defining one or more desired locations along a traveled path.

Other objects, advantages, and features of the invention will become apparent upon consideration of the following detailed description, when taken in conjunction with the accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. To wit, the road profiling system and method thereof of the present disclosure is capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the road profiling system and method thereof of the present disclosure, its advantages, and the specific objects attained by its uses, reference should be made to the accompanying drawings and descriptive matter in which there are illustrated and described the preferred embodiments of the invention.

As such, while embodiments of the road profiling system and method thereof are herein illustrated and described, it is to be appreciated that various changes, rearrangements and modifications may be made therein, without departing from the scope of the invention as defined by the claims.

### BRIEF DESCRIPTION OF THE DRAWINGS

As a compliment to the description and for better understanding of the specification presented herein, 5 pages of drawings are disclosed with an informative, but not limiting, intention.

FIG. 1 is an exemplary perspective view of an embodiment of the profiling system of the present invention;

FIG. 2 is an exemplary, partial, sectional side view of an embodiment of the vehicle module of FIG. 1;

FIG. 3 is an exemplary, partial, sectional side view of an embodiment of the marker of FIG. 1;

FIG. 4 is an exemplary, partial, sectional side view of an embodiment of the marker of FIG. 1 illustrating a typical light path;

FIG. 5 is a flow chart of an embodiment of the profiling method of the present invention.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

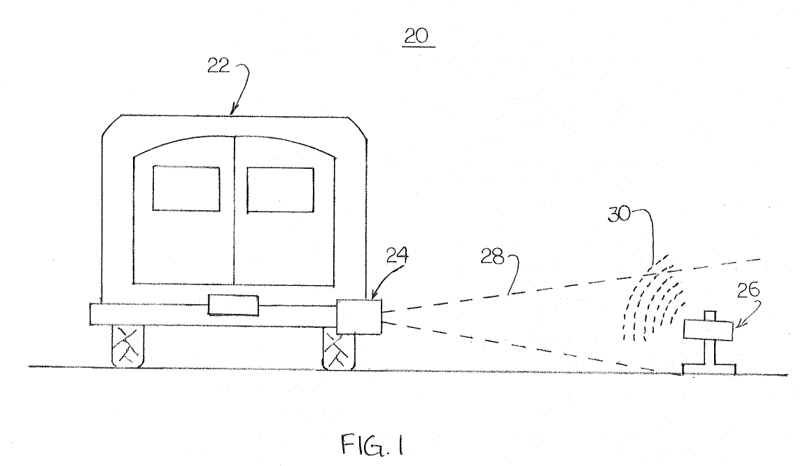

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

The term road is used herein in its generic and ordinary sense and is meant to include highways, streets, runways, rails, and all other surfaces which are traveled by vehicles, such as automotive vehicles, aircraft, railcars, etc. Of course, this is not meant to be limiting in any manner and these roads may take on numerous configurations, and may be used for numerous purposes as is generally known within the art.

As used herein, the term profile and profiling is used in its generic and ordinary sense to mean an analysis representing the extent to which something exhibits various characteristics. For example only, in road profiling applications it is common practice to profile transportation surfaces in order to determine numerous characteristics, thereby allowing the surface to be evaluated. These evaluations may include, again for example only, measuring these surfaces for variations in slope, height, and levelness in order to ensure that surface meets with predefined quality control measures. Of course, this is not meant to be limiting in any manner and these profiles may take on numerous configurations, and may be used for numerous purposes as is generally known within the art.

In the broader sense, it has become common practice to utilize a variety of instrumented vehicles in order to evaluate the conditions of, for example, roadways, runways, railroads, and other transportation surfaces. These evaluations may include, again for example only, measuring these surfaces for variations in slope, height, and levelness in order to ensure that surface meets with predefined quality control measures. During these evaluations it is necessary to isolate, define, or mark out the desired test section(s) (e.g. beginning and end), as well as intermediate points of interest.

In particular, and with respect to these points of interest, it is customary to mark these points manually. This manual process typically comprises the use of painted marks and/or traffic cones which are positioned along the points of interest alongside the traveled path, and serve to advise or alert the vehicle operator of the particular point of interest. The operator would then manually annotate or record these marks in the profile, either by hand or by inputting them into a computer, as the operator drove the vehicle by the point of interest.

In the past, profiling technology was limited to being utilized on relatively slow moving vehicles. As such, the operator had ample time to record these various points of interest in an efficient and safe manner. However, with the advent of test vehicles that are able to profile at increased vehicle speeds, this manual recordation process has become difficult and in many cases, unsafe. For example, the driver (or assistant) was required to manually log the marker (point of interest). With vehicle speeds approaching 60 miles per hour, or faster, this manually marked location was imprecise and would generally introduced an error in the position of these measurements, typically on the order of several feet. Further, if an assistant was unavailable, this procedure must be performed by the driver of the vehicle and as such, introduced an unsafe practice to the routine. Alternatively, in utilizing an assistant, the costs of the profile are accordingly increased.

It is current practice in these systems to utilize a reflective photo switch, mounted on the vehicle, which responds to a reflective surface (marker) placed beside the roadway. In the alternative, a temporary reflective tape may be placed on the roadway itself. However, this approach has several drawbacks. Namely, it only produces a pulse and as such, there is no indication of what the marker identifies. Hence, the manual recordation of what the specific marker was set to identify must still be manually recorded. Other drawbacks include, for example: failure of these vehicle reflective photocells to respond to the marker; or recordation of an event when passing an unintended reflective object. These drawbacks then require the operator to manually intervene. For example, such interventions may be in the form of having the operator temporarily arm the photocell as he approaches the marker. Alternatively, the operator may be forced to abort the run altogether.

Further yet, in many instances intermediate regions, points, or markers must be identified during the profile, and since the aforementioned photocell simply produces a pulse, the operator must manually annotate these points during the run or thereafter. Of course, if done in the post profile stage, error is further introduced. And, if done during the profile, not only is human error involved, but having the operator make these annotations during the run introduces a safety issue. For these and other reasons, the use of this type of photocell system remains undesirable.

In order to solve the problems with the prior art profiling systems, a marker should meet the following criteria: it should respond quickly (accurately) when a designated part of the test vehicle is exactly opposite the marker to be profiled; it should respond reliably at vehicle speeds of 90 feet per second or greater; and, it should be capable of self-identification or self-reporting to the test vehicle.

Numerous technologies were examined in order to determine the preferred embodiments. In one experiment a barcode was utilized. The barcode was placed along the roadway and was to be read by a laser scanner. With the barcode feature, the system was capable of indentifying each marker through a unique or standardized barcode, thereby avoiding operator intervention. However, these systems were problematic as these barcode systems often need to be rescanned due to errors in reading the code. They also exhibited poor response time and therefore were not as accurate as desired. Yet another approach involved active and/or passive Radio Frequency Identification (RFI) devices to accomplish the same goals as outlines above. These systems were also found to be unacceptable due to range and response time problems. Of course, with further development and ever expanding technology advances, these technologies may warrant further investigation.

Accordingly, a need exists for novel systems and methods which have, among other advantages, increased safety and self-reporting features, while simultaneously accurately logging and reporting specific and desired information. Therefore, road profiling systems and methods that solve the aforementioned disadvantages and having the aforementioned advantages is disclosed herein.

The field of surface profiling (e.g. road profiling) is well known within the art and will not be discussed herein. It is to be understood that the present invention is capable of and can be adapted to work with any surface profiling system and more particularly any road profiling system.

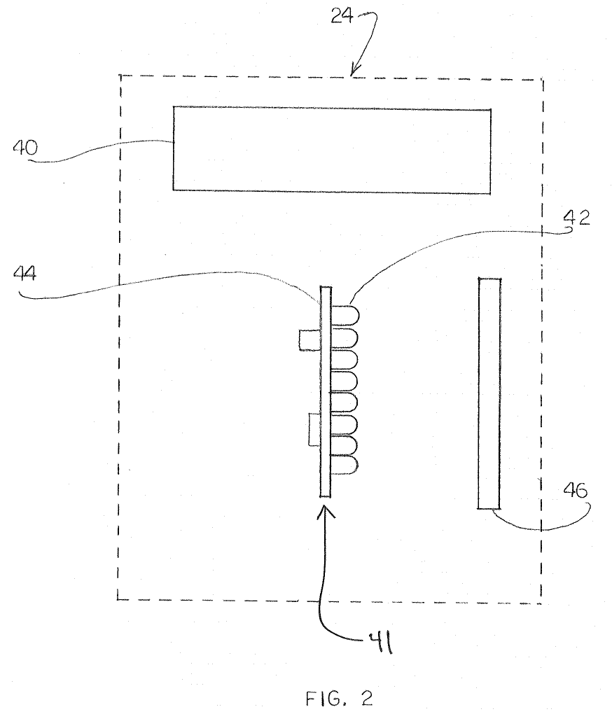

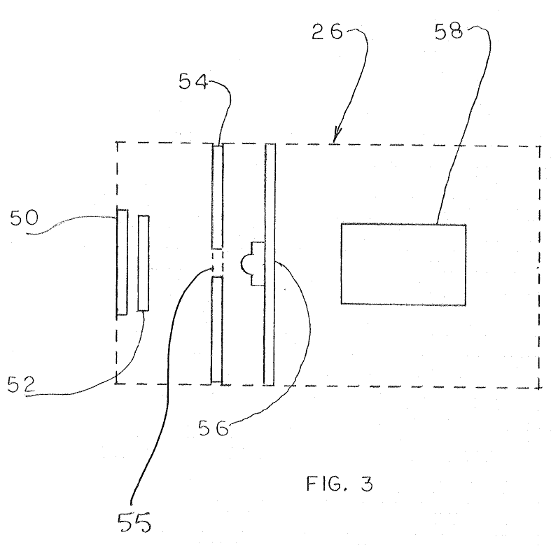

The disadvantages and drawbacks of the prior art are overcome through the road profiling systems and methods of the present invention, wherein one preferred embodiment is disclosed in FIGS. 1-5. Referring now to FIG. 1, there is shown one preferred embodiment of a profiling system 20 which is capable of precisely locating and defining any marked (e.g. desired) position along a traveled path. The system comprises a vehicle module 24, mounted to a test vehicle 22, and a marker 26. Vehicle module 24 (FIG. 2) further comprises a light source 42 and a receiver 40, while marker 26 (FIG. 3) further includes a light sensing device 56 and a transmitter 58.

Although the system and method disclosed herein is capable of and adapted to be utilized in conjunction with marking and profiling any traveled surface, for the sake of brevity we will limit our discussion herein to the use of the system and method in highway profiling. Of course, this is not intended to be limiting in any manner.

In brief then, as vehicle 22 is moved along a desired traveled surface (e.g. a road) and light source 42 is energized, when the emitted light 28 reaches light sensing device 56, transmitter 58 is activated to generate a signal 30 (e.g. a radio frequency (RF) signal) which is received by receiver 40. The RF signal will typically contain information about the marker that has been pre-programmed thereinto. As such, the received signal will indentify the properties of, for example the type of the specific marker, as well as the exact location thereof along the path. In this manner, a system is provided that is fully automated and requires no operator input, while providing specific and accurate location of and identification of one or more markers along a traveled surface.

For example, in a typical highway profiling system the invention can be utilized as follows. Initially the markers can be preprogrammed so as to correlate to set points of interest. For example, a specific location relating to a distance, or a feature such as the start and/or end of a bridge or other surface that is to be noted within the profile of the road. One or more markers 26 are then accurately positioned adjacent the desired features. Once the profile is started, as vehicle 22 is moved along the road and while light source 42 is energized, when the emitted light 28 reaches light sensing device 56 within marker 26, transmitter 58 is activated and will generate signal 30 which is received by receiver 40. As signal 30 will include the preprogrammed information about the specific marker (26), the received signal will thereby indentify the exact location of the marker (26), as well as the specific information preprogrammed into marker 26 (e.g. the start and/or end of a bridge), in a fully automated manner.

The specifics of computing the marker location, as well as programming, encoding, transmitting, and receiving the preprogrammed points of interest are well known in the art and as such are not discussed herein.

Referring now to FIG. 2, there is shown one preferred embodiment of the vehicle module 24 which comprises: an emitter 41 further comprising a light source 42, and a driver circuit 44; a lens 46; and a receiver 40. Vehicle module 24 is designed to emit a relatively narrow and preferably, although not required, vertical emission of light.

Although any light source 42 can and may be utilized, in one preferred embodiment light source 42 comprises a series light emitting diode's (LED's). The LED's are supported and energized by a circuit board 44 as is well known in the art. In one example high output infrared emitting diodes (IRED's) having a wavelength of 940 nanometer (nm) are used. Additionally, in one embodiment, the IRED's are modulated at a rate of 56 KHz. These IRED's were chosen for their effective transmission distance, as well as their ability to be used in varied weather conditions as they are able to be used in fog, mist, and other water laden conditions.

The light emitting from light source 42 is to be received by light sensing device 56. In one embodiment emitted light 28 is focused, concentrated, and/or otherwise shaped by lens 46, and in one preferred embodiment lens 46 comprises a cylindrical lens. The resultant light emission is a narrow vertical emission of light 28 that sweeps along, for example, the roadside

Vehicle module 24 also includes receiver 40 which is configured to receive the signal 30 generated from the transmitter (58) of marker 26. The design, operation and configuration of receiver 40 can be varied to suit the particular needs of the situation and is generally known in the art. In one preferred embodiment a commercial radio frequency (RF) receiver 40 is utilized and as explained previously, is adapted to receive the signal (30) from marker 26. As marker signal 30 includes the encoding of preprogrammed information, receiver 40 receives this identification and/or information in a manner that is generally known within the art. For example, this data can be interpreted and recorded by the test vehicle profiling software. Further, the exact location of marker 26 may also be determined in a manner that is generally known within the art.

Referring now to FIG. 3, there is shown one preferred embodiment of marker 26 which comprises: a light filter 50; a second lens 52; an aperture 54; a light sensing device 56; and a transmitter 58.

The design, operation and configuration of light filter 50 can be varied to suit the particular needs of the situation and is generally known in the art. In one preferred embodiment the light filter (50) is designed to pass through light with a wavelength of 940 nanometers while not allowing other wavelengths to pass-through.

Although any second lens 52 may be utilized, in one preferred embodiment a Fresnel lens is used, for example a cylindrical Fresnel lens, and provides a small, light, inexpensive lens which is able to provide adequate optical qualities. The second lens 52 serves as a compliment to lens 46 in vehicle module 24, and does this by producing a small intense image of light fan (emission) 28.

Although any aperture 54 may be utilized, in one preferred embodiment a relatively narrow slit 55 is used. Narrow slit 55 is adapted to limit the light received by light sensing device 56 and further assist in the accuracy of system 20.

Marker 26 also includes light sensing device 56 which is configured to receive the light generated from light source 42 of vehicle module 24. The design, operation and configuration of light sensing device 56 can be varied to suit the particular needs of the situation and is generally known in the art. In one preferred embodiment a photocell is utilized which responds to light of a fixed wavelength and modulation frequency. In this embodiment the wavelength utilized is 940 nanometers and the modulation frequency is 56 KHz.

Marker 26 also includes transmitter 58 which is configured to generate and transmit signal 30. The design, operation and configuration of transmitter 58 can be varied to suit the particular needs of the situation. In one preferred embodiment a commercial radio frequency (RF) transmitter 58 is utilized and as explained previously, is adapted to transmit signal 30 which is then received by receiver 40.

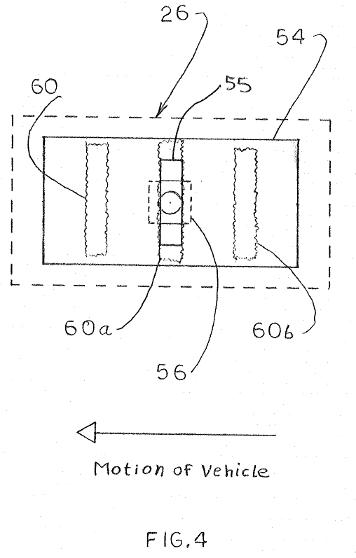

In operation, the transmitted light (28) will pass through filter 50 thereby allowing only light with a wavelength of 940 nanometers to be received by second lens 52. The image formed by lens 52 then sweeps across aperture 54 as the test vehicle travels by. When vehicle module 24 is exactly opposite marker 26 the transmitted light 28 passes through aperture 54 thereby activating light sensing device 56 (FIG. 4). After a predetermined threshold is received, transmitter 58 is initialized and generates signal 30 which is then immediately picked up by receiver 40.

Referring now to FIG. 4, therein illustrated is an exemplary view of this triggering event. As vehicle 22 approaches from, for example the right, an image of the vertical fan of light 28 is formed on slit plate 54. In this case, image 60 is formed to the left side of slit 55. As vehicle 22 moves to the left, the image 60 moves to the right. When vehicle 22, and more particularly when light source 42 and light sensing device 56 are directly in-line, the light image 60a is directly in-line with slit 55, thereby activating photocell 56 and correspondingly, radio transmitter 58. Thus, when the signal generated by transmitter 58 is received by receiver 40, the exact vehicle location and the identity and/or information from the particular marker is recorded. Recordation of this data can be done via numerous systems and is generally known in the art. However, one such example would be recordation through an attached computer system. Finally, as the vehicle proceeds further, the image 60b moves off to the right as the vehicle passes by.

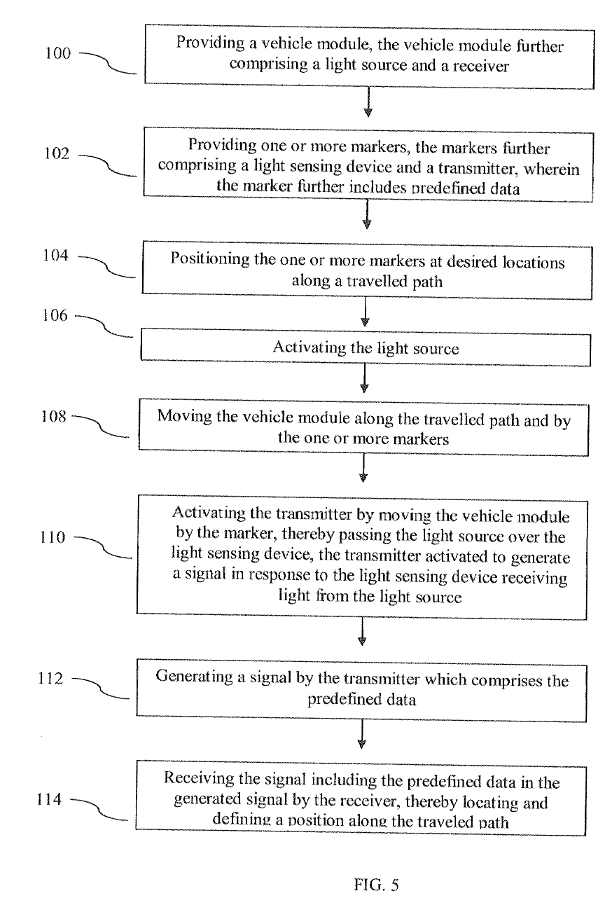

Referring now to FIG. 5, therein illustrated is a flow chart of a method of precisely locating and defining a position along a traveled path, wherein the method comprises the steps of: (100) providing a vehicle module 24, the vehicle module further comprising a light source 42 and a receiver 40; (102) providing one or more markers 26, the markers further comprising a light sensing device 56 and a transmitter 58, wherein the marker further includes predefined data; (104) positioning the one or more markers 26 at desired locations along a traveled path; (106) activating the light source 42; (108) moving the vehicle module 24 along the traveled path and by the one or more markers 26; (110) activating the transmitter 58 by moving the vehicle module 24 by the marker 26, thereby passing the light source 42 over the light sensing device 56, the transmitter 58 activated to generate a signal 30 in response to the light sensing device 56 receiving light from the light source 42; (112) generating a signal 30 by the transmitter 58 which comprises the predefined data; (114) receiving the signal 30 including the predefined data in the generated signal by the receiver 40, thereby locating and defining a position along the traveled path.

Specific manufacturing designs and configurations have not been discussed herein as these specifics as to the construction thereof are generally known in the art. It is also to be understood that various modifications may be made to the system and method thereof, it sequences, methods, orientations, and the like without departing from the inventive concept and that the description contained herein is merely a preferred embodiment and hence, not meant to be limiting unless stated otherwise. Further yet, it is envisioned that the style or configuration of the system can be varied and numerous other configurations can be fabricated.

Advantageously, the profiling system and method of the present invention provides a novel way to accurately locate and identify one or more points of interest, or regions defined by the one or more points of interest. Consequently, the embodiments of the preferred invention disclosed herein reveal a profiling system and method with increased safety and self-reporting features, while simultaneously accurately logging and reporting specific and desired information.

The solutions offered by the invention disclosed herein have thus been attained in an economical, practical, and facile manner. To wit, a novel profiling system and method has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A profiling system to precisely locate and define a position along a traveled path, the system comprising:
a vehicle module, the vehicle module further comprising a light source and a receiver;
a marker, the marker further comprising a light sensing device and a transmitter;
wherein the marker is adapted to respond to the light source by transmitting a signal to the receiver.

2. The system according to claim 1, wherein:
the light source comprises one or more light emitting diodes.

3. The system according to claim 1, wherein:
the receiver is adapted to receive radio frequencies.

4. The system according to claim 1, wherein:
the light sensing device is a photocell.

5. The system according to claim 3, wherein:
the transmitter is adapted to transmit radio frequencies.

6. The system according to claim 1, wherein:
the vehicle module further comprises a lens for focusing an emitted light from the light source.

7. The system according to claim 6, wherein:
the lens is a cylindrical lens.

8. The system according to claim 1, wherein:
the marker further comprises a light filter which is adapted to restrict the light received by the light sensing device.

9. The system according to claim 1, wherein:
the marker further comprises a second lens for focusing received light.

10. The system according to claim 9, wherein:
the second lens is a cylindrical lens.

11. The system according to claim 10, wherein:
the cylindrical lens is a Fresnel lens.

12. The system according to claim 1, wherein:
the marker further comprises an aperture which is adapted to limit the light received by the light sensing device.

13. The system according to claim 12, wherein:
the aperture is rectangular.

14. A profiling system to precisely locate and define a position along a traveled path, the system comprising:
a vehicle module, the vehicle module further comprising a light source, a lens for focusing an emitted light from the light source, and a receiver;
a marker, the marker further comprising a light sensing device, a light filter which is adapted to restrict the light received by the light sensing device, a second lens for focusing the light received by the light sensing device, an aperture which is adapted to limit the light received by the light sensing device, and a transmitter;
wherein the marker is adapted to generate a signal in response to the light sensing device receiving emitted light from the light source, the signal adapted to convey user-defined information, thereby allowing one or more points of interest along a traveled path to be isolated.

15. The system according to claim 14, wherein:
the light source comprises one or more light emitting diodes.

16. The system according to claim 14, wherein:
the light source comprises one or more infrared light emitting diodes.

17. The system according to claim 14, wherein:
The receiver is adapted to receive radio frequencies.

18. The system according to claim 14 wherein:
the light sensing device is a photocell.

19. The system according to claim 17, wherein:
the transmitter is adapted to transmit radio frequencies.

20. The system according to claim 14, wherein:
the lens is a cylindrical lens.

21. The system according to claim 14, wherein:
the second lens is a cylindrical lens.

22. The system according to claim 21, wherein:
the cylindrical lens is a Fresnel lens.

23. The system according to claim 14, wherein:
the aperture is rectangular.

24. A profiling system to precisely locate and define a position along a traveled path, the system comprising:
a vehicle module, the vehicle module further comprising at least one infrared light emitting diode light source, a cylindrical lens for focusing an emitted light from the light source, and a radio frequency receiver;
a marker, the marker further comprising a photocell, a light filter which is adapted to restrict the light received by the photocell, a cylindrical Fresnel lens for focusing the light received by the photocell, a slit aperture which is adapted to limit the light received by the photocell, and a radio frequency transmitter;
wherein the radio frequency transmitter is adapted to generate a radio frequency signal in response to the photocell receiving emitted light from the at least one infrared light emitting diode, the radio frequency signal adapted to convey user-defined information, thereby allowing for the indication of one or more points of interest along a traveled path.

25. A method of precisely marking a position along a traveled path, the method comprising:
providing a vehicle module, the vehicle module further comprising a light source and a receiver;
providing one or more markers, the markers further comprising a light sensing device and a transmitter, wherein the marker further includes predefined data;
positioning the one or more markers at desired locations along a traveled path;
activating the light source;
moving the vehicle module along the traveled path and by the one or more markers;
activating the transmitter by moving the vehicle module by the marker, thereby passing the light source over the light sensing device, the transmitter activated to generate a signal in response to the light sensing device receiving light from the light source;
generating a signal by the transmitter which comprises the predefined data;
receiving the signal including the predefined data in the generated signal by the receiver, thereby defining one or more desired locations along a traveled path.
